(19) United States
(12) Patent Application Publication
(10) Pub. No.: US 2006/0044507 A1
(43) Pub. Date: Mar. 2, 2006

(54) Method of dropping liquid crystal onto a substrate, apparatus for dropping liquid crystal using the same, and method of manufacturing display device using the same

(75) Inventors: Hiroyuki Kamiya, Yongin-si (KR); Doo-Han Chung, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/207,521

(22) Filed: Aug. 19, 2005

(30) Foreign Application Priority Data
Aug. 31, 2004 (KR) 2004-68849

(51) Int. Cl. G02F 1/13

(52) U.S. Cl. 349/187

(57) ABSTRACT

A method of dropping liquid crystal comprises storing the liquid crystal in a receiving space, and pressurizing the liquid crystal to discharge the liquid crystal in at least two directions. An apparatus for dropping liquid crystal comprises a discharge body including a plurality of first discharge holes and a receiving space, the plurality of first discharge holes being formed in a sidewall of the discharge body and the receiving space being connected to the first discharge holes and receiving the liquid crystal, and a discharge unit that is configured to discharge the liquid crystal from the discharge body through the first discharge holes.

### CROSS-REFERENCE TO RELATED APPLICATION

This application claims priority to Korean Patent Application No. 2004-68849 filed on Aug. 31, 2004, the contents of which are herein incorporated by reference in its entirety.

### BACKGROUND OF THE INVENTION

1. Technical Field

The present disclosure relates to a method and an apparatus of dropping liquid crystal, and more particularly to a method and an apparatus of dropping liquid crystal onto a substrate with reduced time, and a method of manufacturing a display device using the same.

2. Discussion of Related Art

In general, a liquid crystal display device displays an image using electrical and optical characteristics of liquid crystal. The liquid crystal display device includes a light providing module and a liquid crystal controlling module to display the image.

The light providing module includes a lamp and an optical unit. The optical unit improves optical characteristics of the light emitted from the lamp. The light providing module provides the light with uniform brightness to the liquid crystal controlling module. The liquid crystal controlling module controls transmissivity of the light provided from the light providing module, thereby generating an image. The liquid crystal controlling module includes two substrates, electrodes and a liquid crystal layer between the electrodes. The electrodes are formed on each of the two substrates. The substrates are disposed facing each other.

A method of arranging liquid crystal between the two substrates includes, for example, a liquid crystal vacuum injection method or a liquid crystal dropping method. In the liquid crystal vacuum injection method, an inner space formed between the two substrates is vaccumized so that the liquid crystal is injected into the inner space from outside of the substrates. In the liquid crystal dropping method, a liquid crystal receiving member is formed on either one of the two substrates. The liquid crystal is dropped onto a space between the substrates formed by the liquid crystal receiving member.

In a conventional liquid crystal dropping method, when the distance between dropped liquid crystals is far, the space between the substrates remains un-filled. When the distance between dropped liquid crystals is short, time for dropping liquid crystal increases.

### SUMMARY OF THE INVENTION

Exemplary embodiments of the present invention provide a method of dropping liquid crystal capable of preventing a substrate from having an unfilled region and reducing time required for dropping the liquid crystal.

Exemplary embodiments of the present invention provide an apparatus for dropping liquid crystal and a method of manufacturing a display device by using the above method.

According to an embodiment of the present invention, a method of dropping liquid crystal is provided. Liquid crystal is stored in a receiving space. The stored liquid crystal is pressurized. The liquid crystal is discharged in at least two directions.

According to an embodiment of the present invention, an apparatus for dropping liquid crystal comprises a discharge body and a discharge unit. The discharge body includes two or more of first discharge holes and a receiving space. The first discharge holes are formed in a sidewall of the discharge body. The receiving space is connected to the first discharge holes and receives the liquid crystal. The discharge unit discharges the liquid crystal from the discharge body through the plurality of first discharge holes.

According to an embodiment of the invention, the method of manufacturing a display device is provided. A closed-loop shape liquid crystal sealing member is formed on a pixel-formed first substrate. At least two liquid droplets containing the liquid crystal are substantially simultaneously dropped onto the substrate. The first substrate and a second substrate are assembled through the liquid crystal sealing member so that the second substrate is positioned opposite the first substrate.

Since the liquid crystal is discharged in at least two directions and substantially simultaneously dropped onto the substrate, the liquid crystal layer may be formed over the substrate, thereby preventing the substrate from having an unfilled region and reducing time for discharging the liquid crystal.

### BRIEF DESCRIPTION OF THE DRAWINGS

Preferred embodiments of the present disclosure can be understood in more detail from the following descriptions taken in conjunction with the accompanying drawings wherein:

FIG. 1 is a flow chart illustrating a method of dropping liquid crystals according to an embodiment of the present invention;

FIG. 2 is a schematic view showing an apparatus for dropping liquid crystal according to an embodiment of the present invention;

FIG. 3 is a cross-sectional view showing a discharge body according to an embodiment of the present invention;

FIG. 4 is a cross-sectional view taken along the line I₁-I₂ shown in FIG. 3;

FIG. 5 is a plan view showing an arrangement of liquid crystal droplets discharged from a discharge body having two discharge holes according to an embodiment of the present invention;

FIG. 6 is a cross-sectional view showing a discharge body according to an embodiment of the present invention;

FIG. 7 is a plan view showing an arrangement of liquid crystals discharged from a discharge body having three discharge holes according to an embodiment of the present invention;

FIG. 8 is a cross-sectional view showing a discharge body according to an embodiment of the present invention;

FIG. 9 is a plan view showing an arrangement of liquid crystal droplets discharged from a discharge body having four discharge holes according to an embodiment of the present invention;

FIG. 10 is a cross-sectional view showing a discharge body according to an embodiment of the present invention;

FIG. 11 is a plan view showing liquid crystal droplets discharged from a discharge body having at least two first discharge holes and a second discharge hole according to an embodiment of the present invention;

FIG. 12 is a cross-sectional view showing a sealing member formed on a substrate according to an embodiment of the present invention;

FIG. 13 is a conceptual plan view showing a pixel formed on a first substrate according to an embodiment of the present invention;

FIG. 14 is a cross-sectional view showing dropping of liquid crystal on an orientation film according to an embodiment of the present invention; and

FIG. 15 is a cross-sectional view showing a first substrate and a second substrate assembled with each other according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the concept of the invention to those skilled in the art.

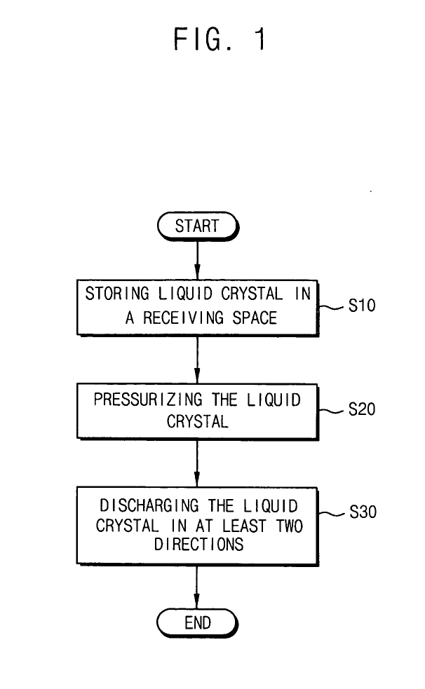

FIG. 1 is a flow chart illustrating a method of dropping liquid crystal according to an embodiment of the present invention.

Referring to FIG. 1, liquid crystal is stored in a receiving space (step S10). The liquid crystal may be dropped onto a display substrate by a liquid crystal dropping method.

Pressure is applied to the liquid crystal stored in the receiving space so that the liquid crystal is discharged from the receiving space to outside (step S20). The pressure applied to the liquid crystal may be generated by gas provided from outside of the receiving space. The gas may include, for example, an inactive gas such as nitrogen (N₂).

By applying the pressure to the liquid crystal stored in the receiving space, the liquid crystal is discharged to the exterior of the receiving space through a discharge hole. The liquid crystal is discharged from the receiving space in the form of droplets.

According to an embodiment of the present invention, the liquid crystal is discharged from the receiving space in two directions (step S30). Preferably, the liquid crystal droplets are simultaneously discharged from the receiving space in two or more directions. The liquid crystal stored in the receiving space is discharged from at least two spots in at least two directions, thereby reducing time for dropping the liquid crystal in one unit area. When the liquid crystal stored in the receiving space is discharged through at least two spots in at least two directions, a distance between dropped liquid crystals may be decreased so that the display substrate may be fully filled with the liquid crystal.

Alternatively, the liquid crystal may be discharged from the receiving space in three directions or four directions to decrease the distance between dropped liquid crystals and reduce time for dropping the liquid crystal.

Hereinafter, an amount of the liquid crystal discharged from the receiving space in one direction, an amount of the liquid crystal discharged from the receiving space in two directions, and an amount of the liquid crystal discharged from the receiving space in four directions are compared.

For example, when about 3.75 mg of liquid crystal is stored in and completely discharged from the receiving space in one direction, the amount of the liquid crystal discharged from the receiving space is about 3.75 mg and the number of the liquid crystal droplets discharged from the receiving space at one time is 1.

When the liquid crystal is discharged from the receiving space, the number of the liquid crystal droplets dropped in a unit area is n, and each of the dropped liquid crystal droplets has a diameter of L1.

When about 3.75 mg of liquid crystal is stored in and discharged from the receiving space in two directions, each amount of the liquid crystal droplets discharged from the receiving space is about 1.875 mg and the number of the liquid crystal droplets simultaneously discharged from the receiving space is 2. When the liquid crystal is discharged from the receiving space, the number of the liquid crystal droplets dropped in a unit area is 2×n, and each of the dropped liquid crystal droplets has a diameter of L2 that is smaller than the diameter of L1.

When about 3.75 mg of liquid crystal is stored in and discharged from the receiving space in four directions, each amount of the liquid crystal droplets discharged from the receiving space is about 0.94 mg and the number of the liquid crystal droplets simultaneously discharged from the receiving space is 4. When the liquid crystal is discharged from the receiving space, the number of the liquid crystal droplets dropped in a unit area is 4×n, and each of the dropped liquid crystals has a diameter of L3 that is smaller than the diameter of L2.

As the number of the liquid crystal droplets simultaneously discharged from the receiving space increases, more liquid crystal is dropped in a unit area. The droplets are spaced so that the liquid crystal droplets do not contact one another, thereby preventing the unit area from having an unfilled region.

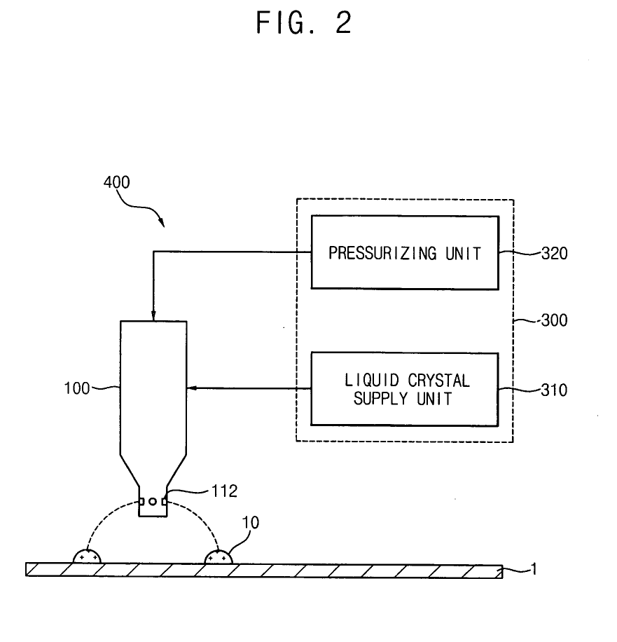

FIG. 2 is a schematic view showing an apparatus for dropping liquid crystal according to an embodiment of the present invention.

Referring to FIG. 2, a liquid crystal dropping apparatus 400 includes a discharge body 100 and a discharge unit 300. The discharge body 100 receives liquid crystal 10 and discharges the liquid crystal 10 in the form of droplets. The discharge body 100 includes a receiving space for receiving the liquid crystal 10 therein and a discharge hole 112 through which the liquid crystal received in the receiving space is discharged.

The discharge unit 300 includes a liquid crystal supply unit 310 and a pressurizing unit 320. The liquid crystal supply unit 310 supplies the liquid crystals 10 to the receiving space of the discharge body 100. The pressurizing unit 320 is connected to the receiving space of the discharge body 100. The pressurizing unit 320 applies pressure to the liquid crystal 10 in the receiving space of the discharge body 100 to discharge the liquid crystal 10 from the discharge body 100 as droplets. The pressurizing unit 320 supplies an inactive gas such as nitrogen (N₂) to the receiving space so that the liquid crystal 10 may be discharged as droplets from the discharge body 100 by the pressure of the nitrogen gas. The liquid crystal 10 discharged from the receiving space of the discharge body 100 is dropped onto a substrate 1. According to an embodiment of the present embodiment, at least two drops of liquid crystal 10 are discharged from the receiving space and dropped onto the substrate 1.

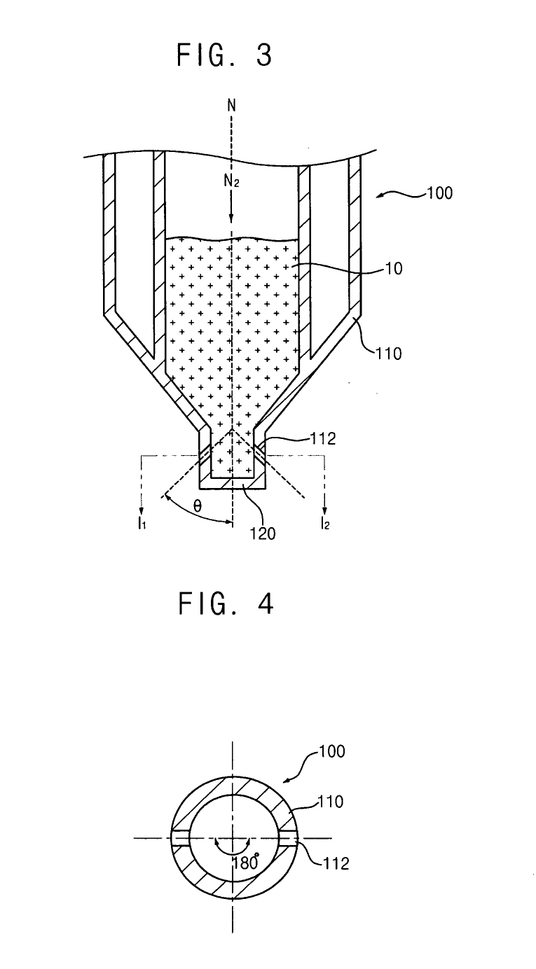

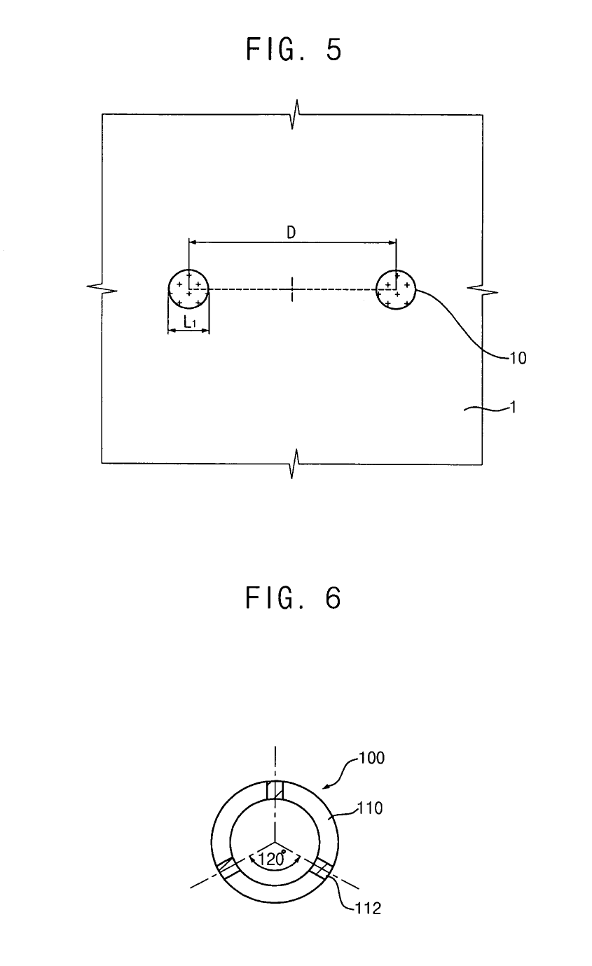

FIG. 3 is a cross-sectional view showing a discharge body according to an embodiment of the present invention. FIG. 4 is a cross-sectional view taken along the line I₁-I₂ shown in FIG. 3. FIG. 5 is a plan view showing an arrangement of liquid crystals discharged from a discharge body having two discharge holes according to an embodiment of the present invention.

Referring to FIGS. 3 to 5, the discharge body 100 includes a sidewall 110 and a bottom wall 120. The discharge body 100 has a truncated cone shape, wherein a diameter of the discharge body 100 is gradually decreased toward an end portion. According to an embodiment of the present invention, a portion of the sidewall 110 and the bottom wall 120 are substantially perpendicular to each other.

The discharge body 100 has at least two discharge holes 112. The liquid crystal received in the discharge body 100 is substantially simultaneously discharged in at least two directions through the discharge holes 112. The two discharge holes 112 according to an embodiment of the present invention, are formed through opposite sides of the sidewall 110 of the discharge body 100 to be opposite to each other. The discharge holes 112 are formed every 180° based on the center of a bottom wall 120 as shown in FIG. 4.

The two discharge holes 112 formed through the sidewall 110 of the discharge body 100 are inclined by an angle θ of about 5° to about 85° with respect to a normal line N, which is substantially perpendicular to the bottom wall 120. Each exit of the discharge holes is formed downwardly.

Referring to FIG. 5, as an angle θ between the discharge holes 112 and the normal line N becomes closer to about 5°, the distance D between the liquid crystals 10 dropped onto the substrate 1 is decreased. As an angle θ between the discharge holes 112 and the normal line N becomes closer to about 85 degrees, the distance D between the liquid crystals 10 dropped onto the substrate 1 is increased. According to an embodiment of the present invention, each droplet of the liquid crystal 10 dropped onto the substrate 1 has a diameter of L1.

When about 3.75 mg of the liquid crystal 10 is stored in the receiving space of the discharge body 100 and the liquid crystal 10 is discharged from the receiving space through each of the two discharge holes 112 in two directions, each droplet of the liquid crystal 10 has the amount of about 1.875 mg.

According to an embodiment of the present invention, the amount of the liquid crystal 10 discharged through each of the discharge holes 112 may be in a range of about 1 mg to about 10 mg. Each amount of the liquid crystal 10 discharged through the discharge holes 112 may be determined based on a size of the substrate 1 onto which the liquid crystals 10 are dropped. Alternatively, the dropped amount of the liquid crystal 10 may be less than about 1 mg or more than about 10 mg based on the size of the substrate 1.

The diameter of the discharge holes 112 affects the distance between the liquid crystal droplets 10 discharged through the discharge holes 112. Accordingly, the distance between the droplets of liquid crystal 10 can be a factor to determine the diameter of the discharge holes 112.

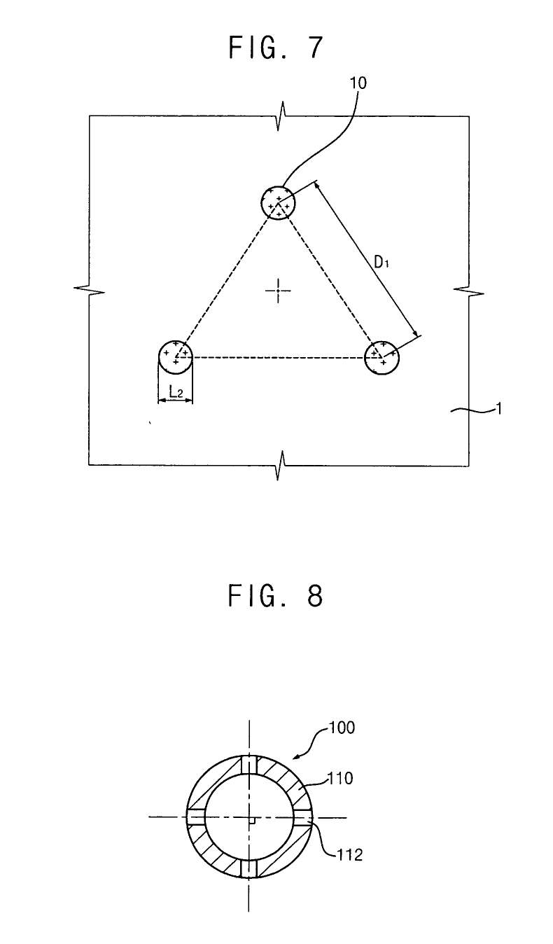

FIG. 6 is a cross-sectional view showing a discharge body according to an embodiment of the present invention. FIG. 7 is a plan view showing an arrangement of liquid crystal droplets discharged from a discharge body having three discharge holes according to an embodiment of the present invention.

Referring to FIGS. 3, 6 and 7, three discharge holes 112 are formed on the discharge body 100. The liquid crystal 10 received in the discharge body 100 is substantially simultaneously discharged in three directions through the discharge holes 112. According to an embodiment of the present invention, the three discharge holes 112 are formed every 120° based on the center of the bottom 120 as shown in FIG. 6.

The three discharge holes 112 formed through the sidewall 110 of the discharge body 100 are inclined by an angle of about 5° to about 85° with respect to the normal line N, which is substantially perpendicular to the bottom 120. Each exit of the discharge holes 112 is formed downwardly.

Referring to FIG. 7, as the angle between the discharge holes 112 and the normal line N becomes closer to about 5°, the distance D1 between the droplets of liquid crystal 10 dropped onto the substrate 1 is decreased. As the angle between the discharge holes 112 and the normal line N becomes closer to about 85°, the distance D1 between the droplets of liquid crystal 10 dropped onto the substrate 1 is increased. According to an embodiment of the present invention, each of the droplets of liquid crystal 10 dropped onto the substrate 1 has a diameter of L2 that is smaller than the diameter of L1.

When about 3.75 mg of the liquid crystal 10 is stored in the receiving space of the discharge body 100 and the liquid crystal 10 is discharged from the receiving space through each of the three discharge holes 112 in three directions, the each droplet of the liquid crystal 10 comprises about 1.25 mg. According to an embodiment of the present invention, the amount of the droplets of liquid crystal 10 discharged through each of the discharge holes 112 may be in a range from about 1 mg to about 10 mg.

Each amount of the liquid crystal 10 discharged through the discharge holes 112 may be determined based on the size of the substrate 1, onto which the liquid crystal 10 is dropped. Alternatively, the dropped amount of the liquid crystal 10 may be less than about 1 mg or more than about 10 mg based on a size of the substrate 1.

The diameter of the discharge holes 112 affects the distance D1 between the liquid crystal drops discharged through the discharge holes 112. The distance D1 between the liquid crystal drops may be a factor to determine the diameter of the discharge holes 112.

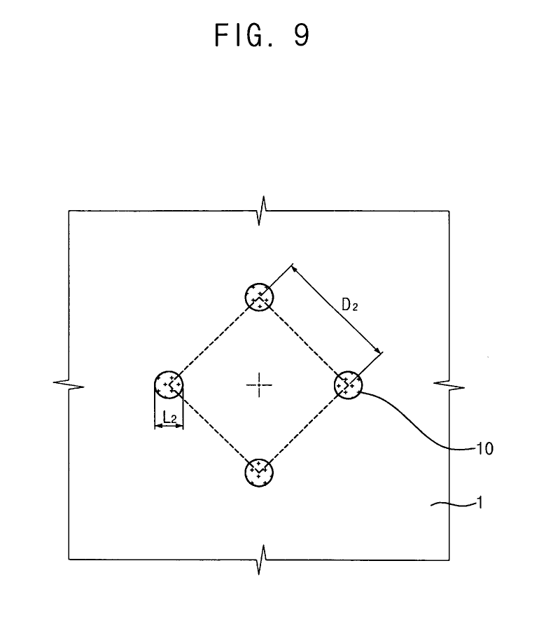

FIG. 8 is a cross-sectional view showing a discharge body according to an embodiment of the present invention. FIG. 9 is a plan view showing an arrangement of droplets of liquid crystal 10 discharged from a discharge body having four discharge holes according to an embodiment of the present invention.

Referring to FIGS. 3, 8 and 9, four discharge holes 112 are formed on the discharge body 100. The liquid crystal 10 received in the discharge body 100 is substantially simultaneously discharged in four directions through the discharge holes 112. According to an embodiment of the present invention, the four discharge holes 112 are formed every 90° based on the center of the bottom 120 as shown in FIG. 8.

The four discharge holes 112 formed through the sidewall 110 of the discharge body 100 are inclined by an angle of about 5° to about 85° with respect to a normal line N, which is substantially vertical to the bottom 120. Each exit of the discharge holes 112 is formed downwardly.

Referring to FIG. 9, as the angle between the discharge holes 112 and the normal N becomes closer to about 5°, the distance D2 between the droplets of liquid crystal 10 dropped onto the substrate 1 is decreased. As the angle between the discharge holes 112 and the normal line N becomes closer to about 85°, the distance D2 between the droplets of liquid crystal 10 dropped onto the substrate 1 is increased. According to an embodiment of the present invention, each of the droplets of liquid crystal 10 dropped onto the substrate 1 has a diameter L3 that is smaller than the diameter L2.

When about 3.75 mg of the liquid crystal 10 is stored in the receiving space of the discharge body 100 and the liquid crystal 10 is discharged from the receiving space through each of the four discharge holes 112 in four directions, then each drop of the liquid crystal 10 has the amount of about 0.938 mg of the liquid crystal 10. According to an embodiment of the present invention, the amount of the liquid crystal 10 discharged through each of the discharge holes 112 may be in a range from about 1 mg to about 10 mg. Each amount of the liquid crystal drops discharged through the discharge holes 112 may be determined based on a size of the substrate 1 onto which the liquid crystals are dropped. Alternatively, the dropped amount of the liquid crystal drops may be less than about 1 mg or more than about 10 mg based on the size of the substrate 1.

The diameter of the discharge holes 112 affects the distance between the drops liquid crystal 10 discharged through the discharge holes 112. The distance between the drops of liquid crystal 10 may be a factor to determine the diameter of the discharge holes 112.

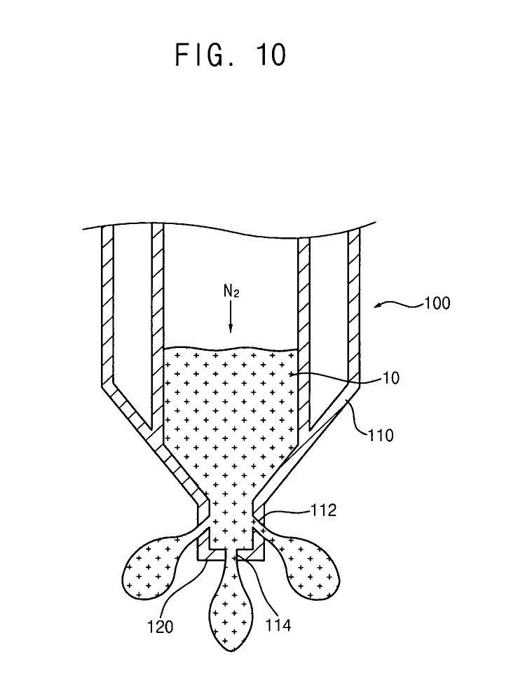

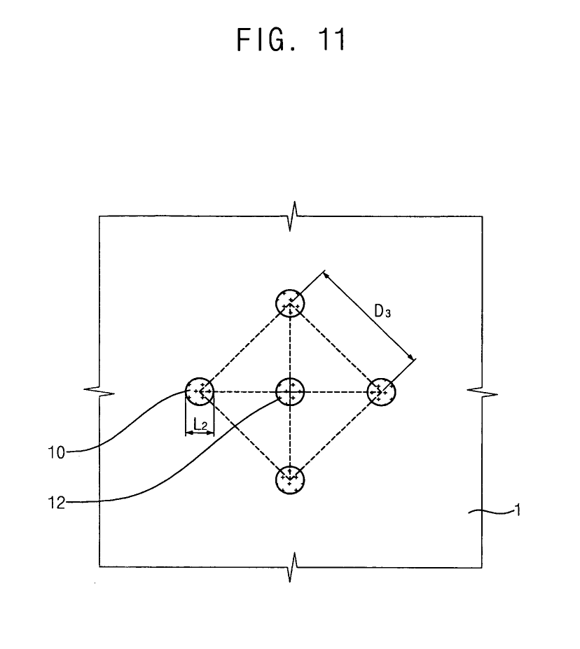

FIG. 10 is a cross-sectional view showing a discharge body according to an embodiment of the present invention. FIG. 11 is a plan view showing drops of liquid crystal discharged from a discharge body having at least two first discharge holes and a second discharge hole according to an embodiment of the present invention.

Referring to FIGS. 10 and 11, the discharge body 100 includes a sidewall 110 and a bottom 120. The discharge body 100 includes a truncated cone shape. A diameter of the discharge body gradually decreases toward the end portion. According to an embodiment of the present invention, a portion of the sidewall 110 and the bottom 120 are substantially perpendicular to each other.

According to an embodiment of the present invention, the discharge body 100 has two or more first discharge holes 112 and one or more second discharge holes 114. The first discharge holes 112 are formed through the sidewall 110. The second discharge hole 114 is formed through the bottom wall 120. According to an embodiment of the present invention, the discharge body 100 includes four first discharge holes 112 and one second discharge hole 114.

Liquid crystal 10 stored in the discharge body 100 is discharged through the first discharge holes 112 and the second discharge hole 114 in at least three directions. At least two first discharge holes 112 formed through the sidewall 110 of the discharge body 100 are inclined by an angle of about 5° to about 85° with respect to a normal line N, which is substantially perpendicular to the bottom wall 120 connected to the sidewalls 110. Each exit of the first discharge holes 112 is formed downwardly. The second discharge hole 114 is formed substantially parallel to the normal line N, which is substantially perpendicular to the bottom 120.

As the angle between the first discharge holes 112 and the normal line N becomes closer to about 5°, the distance D3 between the droplets of liquid crystal 10 dropped onto the substrate 1 becomes smaller. As the angle between the discharge holes 112 and the normal line N becomes closer to about 85°, the distance D3 between the droplets of liquid crystal 10 dropped onto the substrate 1 becomes larger. Referring to FIG. 11, the liquid crystal drop 12 discharged from the second discharge hole 114 is arranged between the droplets of liquid crystal 10 discharged from the first discharge holes 112.

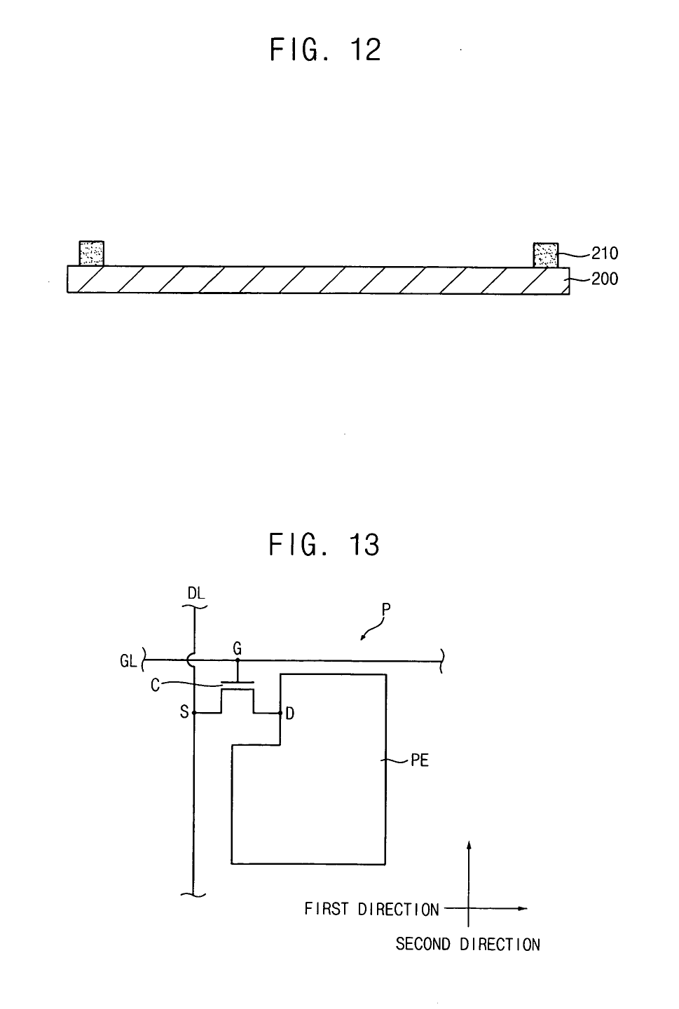

FIG. 12 is a cross-sectional view showing a sealing member formed on a substrate according to an embodiment of the present invention. FIG. 13 is a conceptual plan view showing a pixel formed on a first substrate according to an embodiment of the present invention. Although not shown in FIG. 13, pixels are formed on a first substrate 200 in a matrix configuration. Since each of the pixels has same function and structure, only one pixel P will be described in detail.

Referring to FIGS. 12 and 13, the pixel P may include a gate line GL, a data line DL, a thin film transistor TR, and a pixel electrode PE.

When a resolution of a display device manufactured according to an exemplary embodiment of the present invention is 1024×764, the display device includes 1024×764×3 pixels formed on the first substrate. The display device has 764 gate lines GL extended in a first direction and arranged in a second direction that is substantially perpendicular to the first direction. The gate lines GL are spaced apart from each other by a predetermined distance and substantially parallel to each other. The display device has 1024×3 data lines DL extended in the second direction and arranged in the first direction. The data lines DL are spaced apart from each other by a predetermined distance and substantially parallel to each other.

The gate lines GL and data lines DL are arranged in a lattice shape. A thin film transistor TR is disposed in an area defined by the gate line GL and the data line DL. When the resolution of the display device manufactured according to an embodiment of the present invention is 1024×764, the display device has 1024×764×3 thin film transistors TR as the display device has 1024×764×3 pixels.

The thin film transistor TR includes a gate electrode G, a source electrode S, a channel layer C and a drain electrode D. The gate electrode G is electrically connected to the gate line GL. The source electrode S is electrically connected to the date line DL. The channel layer C outputs a data driving signal applied to the data line DL in response to a gate driving signal. The drain electrode D receives the data driving signal from the channel layer C.

The pixel electrode PE is electrically connected to the drain electrode D. The pixel electrode PE includes a transparent and conductive metal material such as, for example, indium tin oxide, indium zinc oxide, and amorphous indium tin oxide. Alternatively, the pixel electrode PE may include a metal with high reflectivity.

After the pixel P is formed on the first substrate 200, an orientation film (not shown) is formed over the first substrate 200. Orientation grooves (not shown) may be further formed on the orientation film to align the liquid crystals in a predetermined direction.

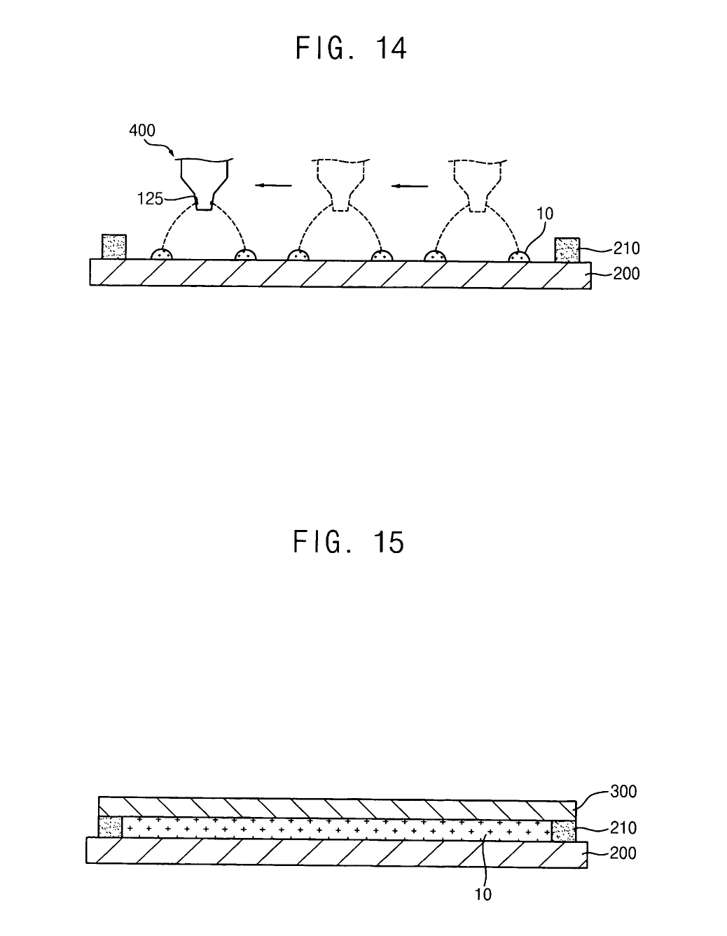

After forming the orientation grooves on the orientation film, a closed loop-shaped sealing member 210 (shown in FIGS. 12 and 14) is formed along an edge of the first substrate 200. The sealing member 210 contains the liquid crystal 10 therein and combines a second substrate 300 (shown in FIG. 15) with the first substrate 200.

FIG. 14 is a cross-sectional view showing a dropping of liquid crystal on an orientation film according to an embodiment of the present invention.

Referring to FIG. 14, with a sealing member 210 formed on a first substrate 200, drops of liquid crystal 10 are dropped into the liquid crystal receiving space formed by the sealing member 210 using a liquid crystal dropping apparatus 400.

The liquid crystal dropping apparatus 400 discharges and drops the liquid crystal 10 in droplet form on the first substrate 200. The liquid crystal dropping apparatus 400 discharges the liquid crystal 10 through at least two discharge holes 125. The number of the drops of liquid crystal 10 dropped at a time is the same as the number of the discharge holes 125.

The liquid crystal dropping apparatus 400 repeatedly performs a process of substantially simultaneously discharging a plurality of drops of liquid crystal to provide the first substrate 200 with the liquid crystal 10.

FIG. 15 is a cross-sectional view showing a first substrate and a second substrate assembled with each other according to an embodiment of the present invention.

Referring to FIG. 15, liquid crystal 10, including a plurality of liquid crystal molecules, is dropped onto the first substrate 200, and the second substrate 300 is disposed on the first substrate 200. The first substrate 200 and the second substrate 300 are assembled to each other via a sealing member 210 interposed therebetween. The assembly of the first substrate 200 and the second substrate 300 may be carried out under a pressure less than atmospheric pressure.

Since the liquid crystal drops are discharged in at least two directions and substantially simultaneously dropped onto the substrate, the liquid crystal may be formed over the substrate without an unfilled region of the substrate and reducing time for discharging the liquid crystal.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of dropping liquid crystal, comprising:
storing the liquid crystal in a receiving space; and
pressurizing the liquid crystal to discharge the liquid crystal in at least two directions.

2. The method of claim 1, wherein the liquid crystal is discharged as droplets.

3. The method of claim 1, wherein the liquid crystal is discharged in four directions.

4. The method of claim 1, wherein an amount of each drop of discharged liquid crystal is in a range of about 1 mg to about 10 mg.

5. The method of claim 1, wherein the liquid crystal is pressurized by an inactive gas.

6. An apparatus for dropping liquid crystal, comprising:
a discharge body including a plurality of first discharge holes and a receiving space, the plurality of first discharge holes being formed in a sidewall of the discharge body and the receiving space being connected to the first discharge holes and receiving the liquid crystal; and
a discharge unit configured to discharge the liquid crystal from the discharge body through the plurality of first discharge holes.

7. The apparatus of claim 6, wherein the discharge body comprises two first discharge holes, and the two first discharge holes are formed opposite to each other.

8. The apparatus of claim 6, wherein the discharge body comprises four first discharge holes, and the four first discharge holes are spaced apart from one another at a constant distance.

9. The apparatus of claim 6, wherein the discharge body further comprises a second discharge hole formed on a bottom side of the discharge body, the bottom side being connected to the sidewall.

10. The apparatus of claim 6, wherein the discharge unit comprises:
a liquid crystal supply unit configured to supply the liquid crystal to the receiving space; and
a pressurizing unit configured to pressurize the liquid crystal to discharge the liquid crystal in the receiving space.

11. The apparatus of claim 10, wherein the pressurizing unit supplies an inactive gas to the receiving space.

12. The apparatus of claim 6, wherein the discharge body comprises a cylindrical shape with a central axis, and the first discharge holes are inclined at an angle of about 5° to about 85° with respect to the central axis.

13. The apparatus of claim 6, wherein an amount of the liquid crystal respectively discharged from each one of the plurality of first discharge holes is in a range of about 1 mg to about 10 mg.

14. A method of manufacturing a display device, the method comprising:
forming a closed loop-shaped liquid crystal sealing member on a first substrate on which a pixel is formed;
substantially simultaneously dropping at least two liquid droplets containing liquid crystal on the first substrate; and
assembling a second substrate to the first substrate using the liquid crystal sealing member, wherein the second substrate is disposed opposite the first substrate.
